(19) United States
(12) Patent Application Publication
(10) Pub. No.: US 2003/0128986 A1
(43) Pub. Date: Jul. 10, 2003

(54) Wavelength interleaving add/drop multiplexer

(75) Inventors: Kuochou Tai, Fremont, CA (US); Xiangdong Qiu, Cupertino, CA (US)

Correspondence Address: Allen, Dyer, Doppelt, Milbrath & Gilchrist, P.A., 1401 Citrus Center, 255 South Orange Avenue, Box 3791, Orlando, FL, 32802-3791, US

(73) Assignee: JDS Uniphase Corporation, San Jose, CA

(21) Appl. No.: 10/324,391

(22) Filed: Dec. 18, 2002

Related U.S. Application Data
(60) Provisional application No. 60/342,633, filed on Dec. 26, 2001.

(51) Int. Cl. H04J 14/02

(52) U.S. Cl. 398/84; 398/85

(57) ABSTRACT

The invention relates to an add/drop multiplexer utilizing at least two stages of wavelength interleaver technology to provide high isolation, while dropping and adding subsets of periodically spaced wavelength channels. The primary function is to separate a first subset of periodically spaced wavelength channels, e.g. even ITU channels, from an input signal, and then to combine the remaining channels, e.g. odd ITU channels, with another subset of channels having the same center wavelengths as the separated channels. The separation and combination are conducted in separate wavelength interleavers providing two stages of filtering to the output signals. Any form of wavelength interleaver is useable in the present invention, including multi-cavity etalon interleavers, Michelson Gires-Tournois interleavers, birefringent crystal interleavers, and birefringent Michelson Gires-Tournois interleavers.

### CROSS-REFERENCE TO RELATED APPLICATIONS

The present invention claims priority from U.S. Patent Application No. 60/342,633 filed Dec. 26, 2001.

### TECHNICAL FIELD

The present invention relates to an add/drop multiplexer, and in particular to a wavelength interleaving add/drop mulitplexer with high isolation.

### BACKGROUND OF THE INVENTION

Using optical signals as a means of carrying channeled information at high speeds through an optical path such as an optical waveguide, e.g. optical fibers, is preferable over other schemes, such as those using microwave links, coaxial cables, and twisted copper wires, because propagation loss is lower in an optical path, and optical systems are immune to Electro-Magnetic Interference (EMI) and have higher channel capacities. High-speed optical systems have signaling rates of several mega-bits per second to several tens of giga-bits per second.

Optical communication systems are nearly ubiquitous in communication networks. The expression herein “Optical communication system” relates to any system that uses optical signals at any wavelength to convey information between two points through any optical path. Optical communication systems are described for example, in Gower, Ed. Optical communication Systems, (Prentice Hall, NY) 1993, and by P. E. Green, Jr in “Fiber optic networks” (Prentice Hall New Jersey) 1993, which are incorporated herein by reference.

As communication capacity is further increased to transmit an ever-increasing amount of information on optical fibers, data transmission rates increase and available bandwidth becomes a scarce resource.

High speed data signals are plural signals that are formed by the aggregation (or multiplexing) of several data streams to share a transmission medium for transmitting data to a distant location. Wavelength Division Multiplexing (WDM) is commonly used in optical communications systems as a means to more efficiently use available resources. In WDM each high-speed data channel transmits its information at a pre-allocated wavelength on a single optical waveguide. At a receiver end, channels of different wavelengths are generally separated by narrow band filters and then detected or used for further processing. In practice, the number of channels that can be carried by a single optical waveguide in a WDM system is limited by crosstalk, narrow operating bandwidth of optical amplifiers and/or optical fiber non-linearities. Moreover such systems require an accurate band selection, stable tunable lasers or filters, and spectral purity that increase the cost of WDM systems and add to their complexity. This invention relates to a method and system for filtering or separating closely spaced channels in a manner that would otherwise not be suitably filtered by conventional optical filters.

Currently, internationally agreed upon channel spacing for high-speed optical transmission systems is 100 Ghz, equivalent to 0.8 nm, surpassing, for example 200 Ghz channel spacing equivalent to 1.6 nanometers between adjacent channels. Of course, as the separation in wavelength between adjacent channels decreases, the requirement for more precise de-multiplexing circuitry capable of ultra-narrow-band filtering, absent crosstalk, increases. The use of conventional dichroic filters to separate channels spaced by 0.4 nm or less without crosstalk, is not practicable; such filters being difficult if not impossible to manufacture.

There are various forms of multiplexers and demultiplexers commercially available; interleavers and deinterleavers are a subset of multiplexers or demultiplexers which generally use a periodic filter having a period that is related, by way of being a multiple of or corresponding directly, to inter channel spacing of adjacent channels. The interleaver combines (interleave) or separates (de-interleave) closely spaced adjacent channels corresponding to closely spaced center wavelengths. For example, when a composite optical signal, having a stream of sequential channels 1 through n defined by respective sequential center wavelengths λ₁, λ₂, λ₃, λ₄, λ₅, α₆ . . . λₙ, is provided at the input port of a three port deinterleaver, odd channels 1, 3, 5, . . . n-1 are output on one of the two output ports, and even channels 2, 4, 6, . . . n are be output to the other of the two output ports. Of course, in a multiplexing or interleaving mode of operation the two output ports referred to heretofore, serve as input ports and the other of the three ports serves as an output port. In this manner the device operates as multiplexer or interleaver. Within this specification, only one of the terms interleaver or deinterleaver may be used on occasion for simplicity, however it should be understood that the device in it's most general form, in the absence of isolators, is bi-directional and can function in one direction as an interleaver and in an opposite direction as a deinterleaver.

By way of background U.S. Pat. No. 4,566,761 in the name of Carlson assigned to GTE, issued Jan. 28, 1986 illustrates a 3-port interleaver deinterleaver which uses a plurality of birefringent plates to de-interleave channels corresponding to closely spaced wavelengths. Carlson makes use of a polarization beam splitter (PBS) to separate an input beam into two orthogonal polarized sub-beams, which traverse a set of birefringent wave plates providing output beams that have a periodic phase with wavelength response. These beams subsequently are provided to a beam splitting cube where orthogonal components having similar wavelengths are combined such that even channels emerge from one port and odd channels emerge from another port of the PBS, which serves as a combiner and not a splitter in this instance.

U.S. Pat. No. 5,912,748 in the name of Wu et al. discloses a three-port interleaver in which switching is accomplished in a polarization dependent manner by actively controlling a controllable polarization rotator. Although this device appears to achieve its intended purpose, its functionality is somewhat limited.

Interleavers may take other forms including a Michelson Gires Tournois (MGT) interleaver disclosed in U.S. Pat. No. 6,222,958 issued Apr. 24, 2001 in the name of Reza Paiam et al; a Birefringent Michelson Gires Tournois (BGT) interleaver disclosed in U.S. Pat. Nos. 6,130,971 issued Oct. 10, 2000, and 6,169,604 issued Jan. 2, 2001 both in the name of Simon Cao and a multi-cavity Fabry-Perot etalon interleaver (MCI) disclosed in U.S. Pat. No. 6,125,220 issued Sep. 26, 2000 in the name of Nigel Copner et al. All of the aforementioned references are incorporated herein by reference.

There are applications in the field of routing optical signals where adding and dropping channels or groups of channels, such as even or odd channels, is desired. For example, it may be desirous in a system having channels 1, 2, 3, 4, 5, 6, . . . n corresponding to center wavelengths λ₁, λ₂, λ₃, λ₄, λ₅, λ₆ . . . λₙ, to drop even channels 2, 4, 6, . . . n corresponding to center wavelengths λ₂, λ₄, λ₆, . . . λₙ₋₁, and add in new channels 2′, 4′, 6′ . . . n′. An optical multiplexing or de-multiplexing system which could accomplish this using birefringent crystal interleaver (BCI) technology is disclosed in United States Patent Publication No. 2002/0076144, published Jun. 20, 2002 by the present applicant, which is incorporated herein by reference. FIG. 1 illustrates one embodiment of the aforementioned prior art cross-connect system, in which input ports 1 and 2 launch first and second mixed signals, respectively, each containing odd and even subsets of channels through a stack 3 of birefringent plates. The stack 3 is arranged so that the odd channels from the first signal are oriented with the same polarization as the even channels from the second signal for output the third port 4, and so that the even channels from the first signal are oriented with the same polarization as the odd channels from the second signal for output the fourth port 5. Each port includes a birefringent crystal 6 for separating input beams into orthogonally polarized components or for combining output beams components into a unified beam. Waveplates 7 ensure that both input sub-beams from a given port have the same polarization for passage through the stack 3 or that both output sub-beams have orthogonal polarizations for recombination. Moreover, the waveplates 7 ensure that the sub-beams from the first port 1 have a different polarization than the sub-beams from second port 2, thereby enabling the waveplate stack to adjust the polarizations of the individual subsets of channels appropriately to provide intermingling of the different subsets of channels. Polarization beam splitting (PBS) prisms 8 direct the sub-beams from the input ports 1 and 2, through the waveplate stack 3, to the appropriate output ports 4 and 5 according to the polarization of the sub-beam. Waveplates 9a, 9b, and 9c orient the sub-beams correctly for passage through the waveplate stack 3, in particular for re-orienting the sub-beams between the first stage 10, with an optical path length L, and the second stage 11, with an optical path length 2L, wherein L is selected depending upon the desired free spectral range (FSR) as is well known in the art.

In addition to the aforementioned functionality, achieving a very high extinction ratio is of also of paramount importance. With reference to FIG. 2, if the even group of channels E from a first port 1 are to be dropped to the forth port 5 prior to adding in a new group of channels E′ from the second port 2, removing essentially all of the original even group e along with the residual odd group o′ from port 2 is important, if the new even group E′ and odd group O are to remain pure upon introduction. Since these signals typically carry data, removing all of the old data before introducing the new data ensures the integrity or purity of the new data which would otherwise be “polluted” by the presence of old data at the same center wavelengths.

Advantageously, the present invention provides a filter having at least 4 ports, and two filter stages for at least one of the output signals passing therethrough.

This new structure employs double stage filters that can obtain a better (purified) pass-band transmission, and incorporates a fault-tolerant that results in low cross-talk between channels.

An object of the present invention is to overcome the shortcomings of the prior art by providing a wavelength interleaving device with add/drop functionality providing high isolation.

### SUMMARY OF TIE INVENTION

Accordingly, the present invention relates to an add/drop multiplexing device comprising:

a first port for launching a first signal comprising a plurality of wavelength channels;

a first wavelength interleaving filter for separating a first subset of periodically spaced channels, defined by a first set of center wavelengths, from a second subset of channels, defined by a second set of center wavelengths, the second subset of channels including some residual transmission components of the first subset of channels;

a second port for launching a second signal comprising a third subset of channels, each channel defined by a center wavelength from the first set of center wavelengths;

a second wavelength interleaving filter for combining the second subset of channels with the third subset of channels into a third signal, while filtering out residual transmission components of the first subset of channels; and

a third port for outputting the third signal.

Another aspect of the present invention relates to an add/drop multiplexing device comprising:

a first port for launching a first signal comprising a plurality of wavelength channels;

a first wavelength interleaving filter for separating a first subset of periodically spaced channels from a second subset, the first subset of channels including some residual transmission components of the second subset of channels;

a second wavelength interleaving filter for separating the second subset of channels into a third subset of periodically spaced channels and a fourth subset of channels;

a second port for receiving the third subset of periodically spaced channels;

a third port for launching a fifth subset of periodically spaced channels, the fifth subset of channels having center wavelengths the same as center wavelengths of the fourth subset of channels;

a third wavelength interleaving filter for combining the fifth subset of channels with the fourth subset of channels forming a first combined set of channels;

a fourth wavelength interleaving filter for combining the first combined set of channels with the first subset of channels forming a second combined set of channels, while filtering out some residual transmission components of the second subset of channels; and

a fourth port for outputting the second combined set of channels.

### BRIEF DESCRIPTION OF THE DRAWINGS

The invention will be described in greater detail with reference to the accompanying drawings which represent preferred embodiments thereof, wherein:

FIG. 1 illustrates a conventional single pass four port add/drop cross-connect;

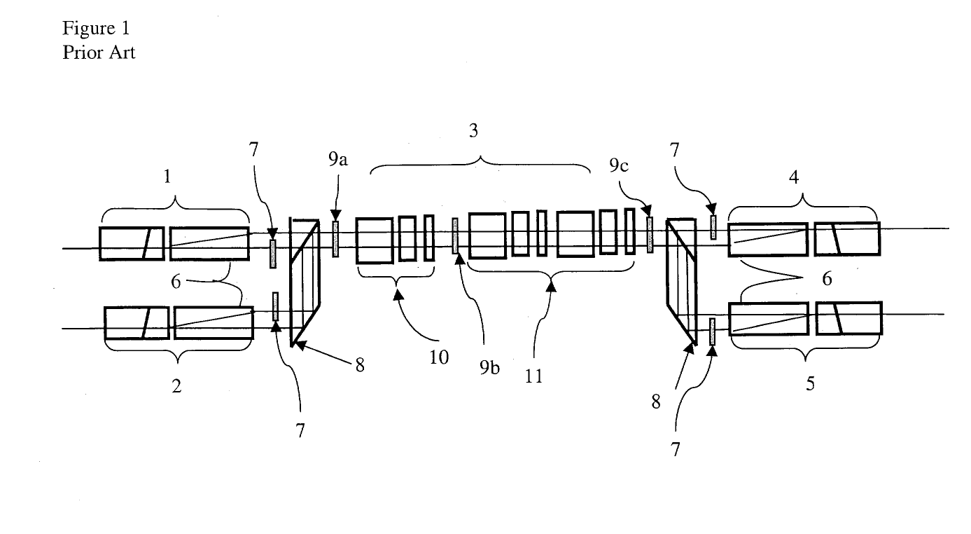

FIG. 2 schematically illustrates the overall functionality of the conventional add/drop cross-connect of FIG. 1;

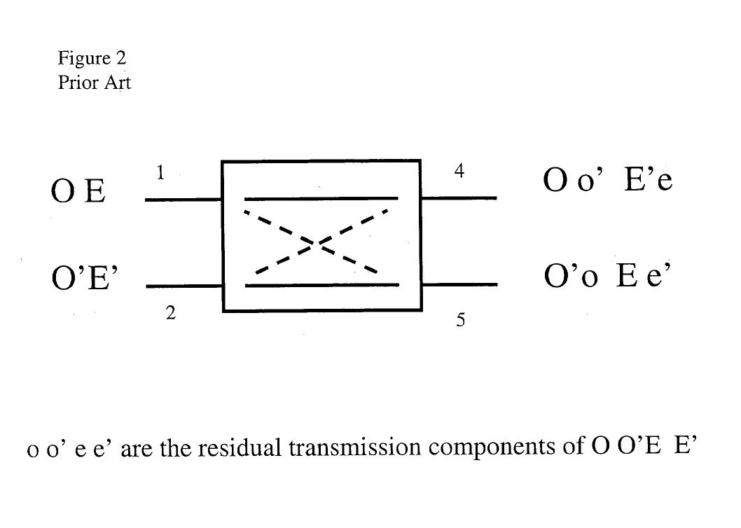

FIG. 3 schematically illustrates the overall functionality of the add/drop multiplexer according to the present invention;

FIG. 4 schematically illustrates the functionality of the elements of the add/drop multiplexer of FIG. 3;

FIG. 5 illustrates a first embodiment of the add/drop multiplexer according to FIGS. 3 and 4 using BCI technology;

FIG. 6 illustrates an alternative embodiment of the add/drop multiplexer of FIG. 5;

FIG. 7 schematically illustrates the overall functionality of a second embodiment of the add/drop multiplexer according to the present invention;

FIG. 8 schematically illustrates the functionality of the elements of the add/drop multiplexer of FIG. 7;

FIG. 9 illustrates a BCI add/drop multiplexer according FIGS. 7 and 8;

FIG. 10 illustrates the first embodiment of the add/drop muliplexer according to FIGS. 3 and 4 utilizing MCI technology;

FIG. 11 illustrates the second embodiment of the add/drop multiplexer according to FIGS. 7 and 8 utilizing MCI technology;

FIG. 12 illustrates the first embodiment of the add/drop multiplexer according to FIGS. 3 and 4 utilizing MGT or BGT technology;

FIG. 13 illustrates the second embodiment of the add/drop multiplexer according to FIGS. 7 and 8 utilizing MGT or BGT technology;

FIG. 14 illustrates a resonant cavity from a BGT interleaver;

FIG. 15 illustrates the first embodiment of the add/drop multiplexer according to FIGS. 3 and 4 utilizing BGT technology;

FIG. 16 illustrates the second embodiment of the add/drop multiplexer according to FIGS. 7 and 8 utilizing BGT technology;

FIG. 17 schematically illustrates a third embodiment of the add/drop muliplexer according to the present invention;

FIG. 18 illustrates the third embodiment according to FIG. 17 utilizing BCI technology;

FIG. 19 illustrates the third embodiment according to FIG. 17 utilizing MCI technology; and

FIG. 20 illustrates the third embodiment according to FIG. 17 utilizing MGT or BGT technology.

### DETAILED DESCRIPTION

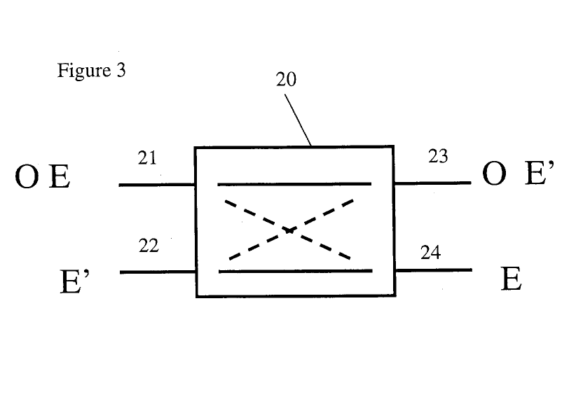

The overall functionality of a first embodiment of the present invention is illustrated with reference to FIG. 3, in which a wavelength interleaving add/drop muliplexer (ADM) 20 includes an input port 21, an add port 22, an output port 23, and a drop port 24. A main signal with odd and even ITU channels (OE) is launched via the input port 21, while an add signal with just even ITU channels (E′) is launched via the add port 22. The ADM 20 filters and combines the odd ITU channels O from the main signal with the even ITU channels (E′) from the add signal for output via the output port 23. The even ITU channels (E) from the main signal are output via the drop port 24.

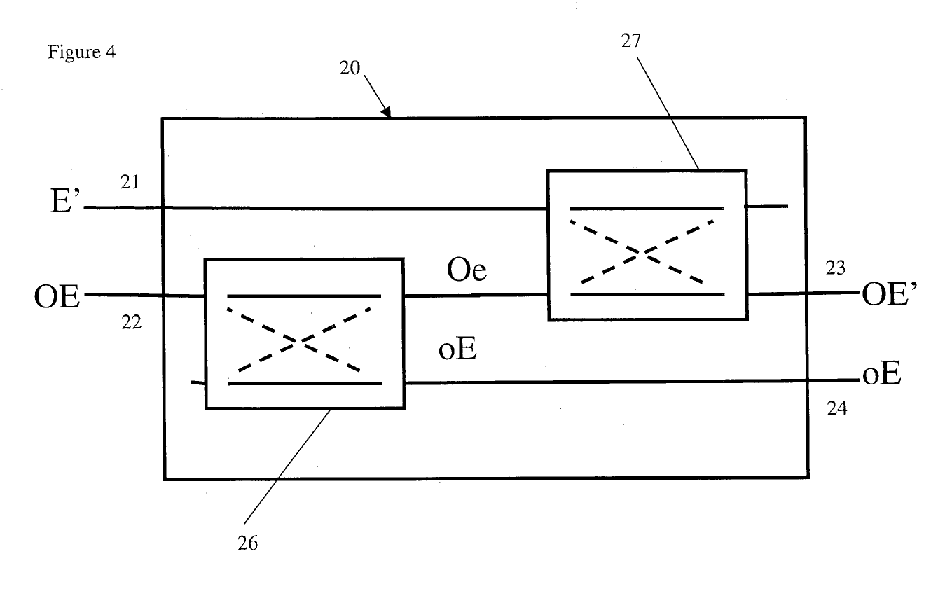

The diagram in FIG. 4 provides a better indication of the individual elements in the ADM 20, which includes a first wavelength interleaving (WI) filter 26 and a second wavelength interleaving (WI) filter 27. The first WI filter 26 enables the subset of odd ITU channels O to be separated from the subset of even ITU channels E; however, the subset of odd ITU channels O are left with residual transmission component e from the even ITU channels E, and the subset of even ITU channels E are left with residual transmission component o from the odd ITU channels O. Therefore, the second WI filter 27 combines the add signal containing a subset of even ITU channels E′ with the subset of odd ITU channels O, and ensures that the residual component o is eliminated. In this embodiment, the ADM 20 does not provide the subset of even ITU channels E output via the drop port 24 with the necessary additional filtering, and as a result the dropped signal contains residual component o.

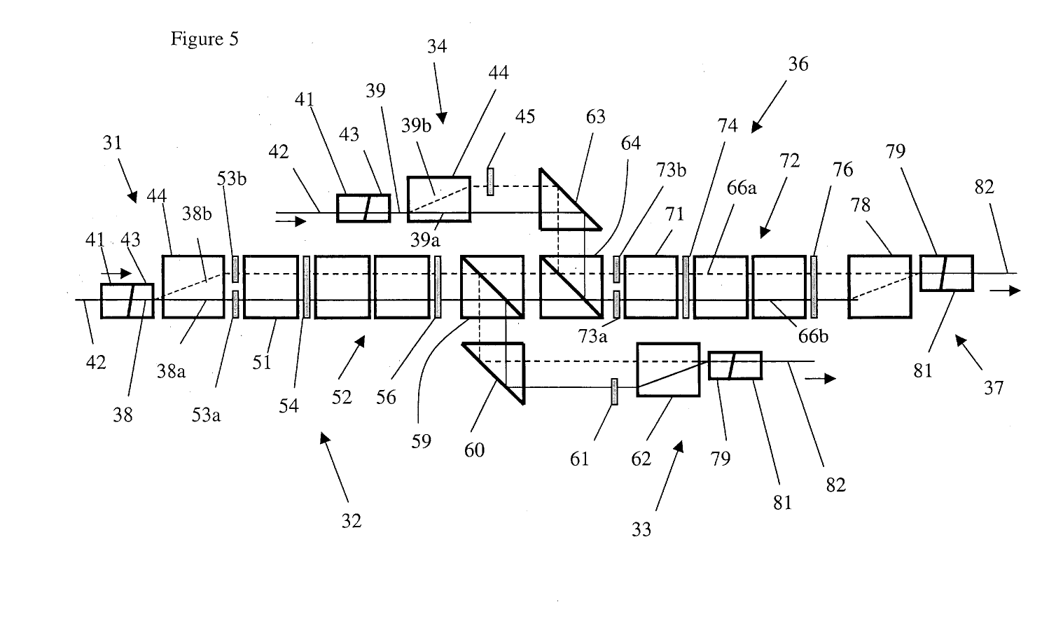

A specific example of a WI ADM providing the functionality defined by FIGS. 3 and 4 using birefringent crystal interleaver (BCI) technology is illustrated in FIG. 5. The WI ADM includes an input port 31, a first WI filter 32, a drop port 33, an add port 34, a second WI filter 36, and an output port 37.

The input port 31 receives an input signal 38 comprising both odd (O) and even (E) ITU channels, and the add port 34 receives an add signal 39 comprising either ITU odd (O′) or even ITU (E′). Each of the input and add ports 31 and 34, respectively, includes a ferrule 41 encasing an end of an optical fiber 42, which is optically coupled to a collimating lens 43. A birefringent crystal 44, e.g. rutile, is provided to split the incoming beams 38 and 39 into orthogonal components 38a, 38b, 39a, and 39b. A half wave plate 45 positioned in the path of one of the components from the add port 34 ensures both components have the same polarization for launching into the second WI filter 36.

The first WI filter 32 includes a first stage 51 of length L and a second stage 52 of length 2L. The lengths L and 2L are determined using the refractive index of the material based on the desired free spectral range (FSR) of the channels, e.g. 100 GHz or 50 GHz, as is well known in the art. The first and second stages provide first and second Fourier terms, which are combined to provide the desired “flat-top” response. Initial waveplates 53a and 53b oriented at + and −22.5°, respectively, rotate the polarizations of the input sub-beams 38a and 38b, respectively, to ensure that both sub-beams 38a and 38b have the same polarization, and to ensure that both sub-beams 38a and 38b enter the first stage 51 with the appropriate orientation relative to the major axis thereof. A second waveplate 54 oriented at 28.5° is provided between the first stage 51 and the second stage 52 to ensure that both the sub-beams 38a and 38b enter the second stage 52 with the appropriate orientation relative to the major axis thereof. Similarly, a third waveplate 56 oriented at 8° is provided after the second stage 52 to make a minor adjustment to the polarization of the sub-beams 38a and 38b. Passage through the first WI filter 32 results in the polarization of a first subset of periodically spaced channels, e.g. odd or even ITU channels, to be orthogonal to the polarization of a second subset of channels. A first polarization beam splitter (PBS) 59 physically separates the second subset, e.g. the even ITU channels E, in the sub-beams 38a and 38b from the first subset of channels, e.g. the odd ITU channels O, and directs the second subset of channels, e.g. the even ITU channels E, to the drop port 33. Optionally, an additional PBS prism 60 is provided to direct the second subset of channels to the drop port 33 disposed adjacent to the output port 37. The drop port 33 includes a half wave plate (HWP) 61 for rotating the polarization of one of the sub-beams comprising the second subset of channels, e.g. the even ITU channels E, and a birefringent crystal 62 for recombining the orthogonally polarized sub-beams.

Similarly, a PBS prism 63 is provided to redirect the sub-beams 39a and 39b from the add port 34, which is positioned adjacent to the input port 31. A second PBS 64 passes the portions of the sub-beams 38a and 38b with the first subset of channels, e.g. the odd channels O, therethrough to the second WI filter 36, while redirecting the sub-beams 39a and 39b with channels from the second subset of channels, e.g. even ITU channels E′, to the second WI filter forming mixed beams 66a and 66b. Within the mixed beams 66a and 66b, the portion of the sub-beams 38a and 38b with the first subset of channels, e.g. the odd ITU channels O, are originally orthogonally polarized to the sub-beams 39a and 39b with the second subset of channels, e.g. the even channels E′.

Like the first WI filter 32, the second WI filter 36 includes a first stage 71 and a second stage 72. Two initial waveplates 73a and 73b rotate the polarizations of the mixed beams 66a and 66b, respectively, in opposite directions, e.g. +/−22.5°. Second and third waveplate 74 and 76, identical to waveplates 54 and 56, respectively, are provided on either side of the second stage 72 for reasons that have been hereinbefore discussed.

The output port 37, like the drop port 33, includes a birefringent crystal 78, a lens 79, and a ferrule 81 encasing an end of an optical fiber 82.

As a result of passage through the second WI filter 36, the polarization of the light containing the second subset of channels, e.g. the even ITU channels E′, is rotated by 90° more than the polarization of the light containing the first subset of channels, e.g. the odd ITU channels O. Therefore, since the mixed beam 66a and 66b each started with orthogonally polarized components, the polarization of the components with the second subset of channels, e.g. the even ITU channels, is rotated parallel to the polarization of the components with the first subset of channels, e.g. the odd ITU channels. Moreover, the polarization of the one sub-beam 66a is orthogonal to the polarization of the other sub-beam 66b, so that the birefringent crystal 78 can recombine the two sub-beams 66a and 66b for output via the output port 37.

Any residual transmission component e′ from the input signal 38 will be launched into the second WI filter 36 with a polarization orthogonal to that of the sub-beams 39a and 39b. Accordingly, the WI filter 36 will rotate the polarization of the component e′, thereby preventing the component from being recombined by the birefringent crystal 78.

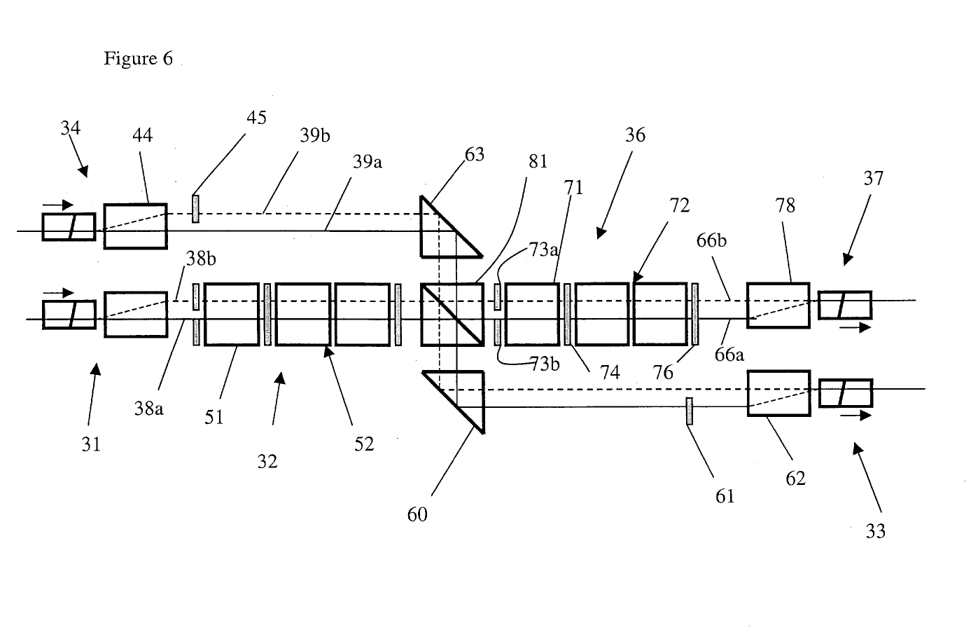

The device illustrated in FIG. 6 is identical to the device of FIG. 5, except that the first and second PBS 59 and 64 are replaced by a single PBS 81, which performs all the functions of the other two.

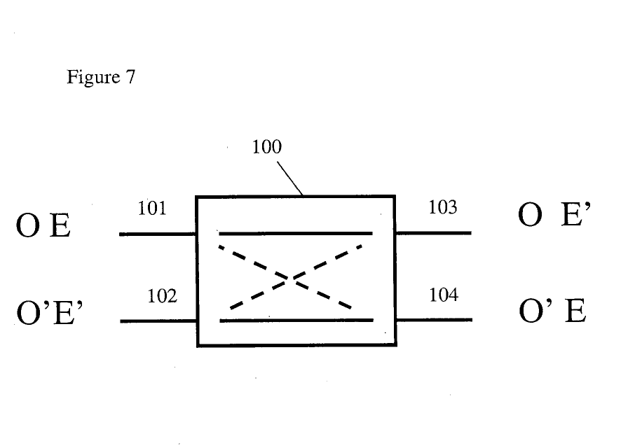

As will be noted in the previous embodiment, the signal dropped to the drop port 33 contains some residual transmission component o, because the dropped signal does not undergo a second stage of filtering. However, the next embodiments, detailed with reference to FIGS. 7 to 11, deal with full double stage cross-connect designs, which initially receives two mixed beams, and outputs two new mixed beams with periodically spaced wavelength channels from both input signals. FIG. 7 details how the WI ADM 100 functions by inputting first and second mixed signal with even and odd channels OE and O′E′ into first and second input ports 101 and 102, respectively, and outputting third and fourth mixed signals with interchanged even and odd channels OE′ and O′ E to first and second output ports 103 and 104. Even and odd channels are referred to for convenience; however, any set of periodically spaced channels can be separated out, and is therefore within the scope of the invention.

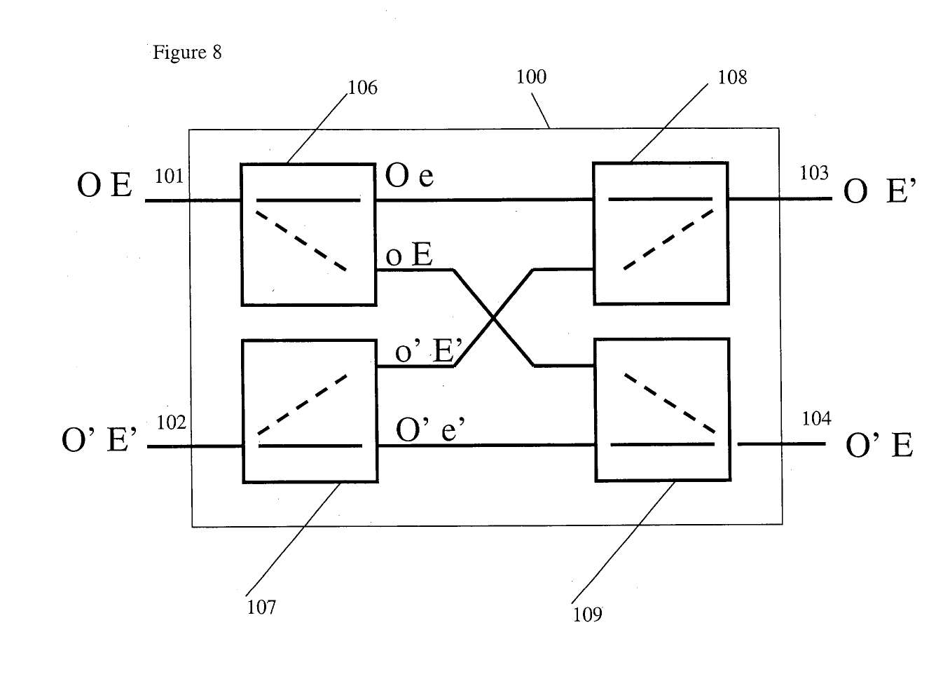

FIG. 8 illustrates in greater detail the function of the WI ADM 100, in which the first mixed signal OE is passed through a first WI filter 106, which enables the odd channels O to be separated from the even channels E with residual components e and o therewith. Similarly, the second mixed signal O′E′ is passed through a second WI filter 107 providing a first sub-beam with even channels E′ and a second sub-beams with odd channels O′. Again residual components o′ and e′ are found with the sub-beams E′ and O′, respectively. A third WI filter 108 is provided to combine the odd channels O with the even channels E′, while eliminating the residual components e and o′. A fourth WI filter 109 is provide to combine the odd channels O′ with the even channels E, while eliminating the residual components o and e′.

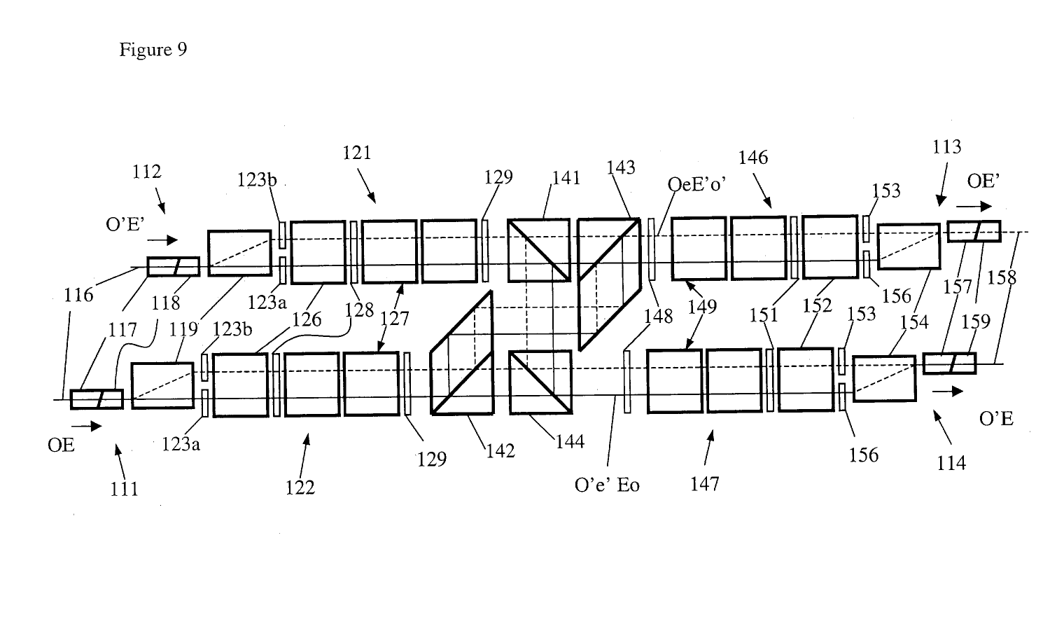

A BCI double stage ADM is illustrated in FIG. 9, and includes a first input port 111 for launching a first input beam OE, a second input port 112 for launching a second input beam O′E′, a first output port 113 for outputting a first combined beam OE′, and a second output port 114 for outputting a second combined beam O′E. The first and second input ports 111 and 112 are substantially identical, and include an end of an optical fiber 116 encased in a ferrule 117 optically coupled to a collimating lens 118 (e.g. a GRIN lens). A birefringent crystal 119 separates the input beams OE and O′E′ into orthogonally polarized sub-beams. First and second WI filters 121 and 122 are also substantially identical, and include first waveplates 123a and 123b oriented (e.g. +/−22.5°) for rotating the polarizations of the sub-beams in opposite directions, so that both polarizations are the same and oriented correctly for the WI filters. As above, the WI filters 121 and 122 are comprised of first and second stages 126 and 127 with a second waveplate 128 (e.g. @ 28.5°) therebetween. A third waveplate 129 (e.g. @ 8°) and is positioned at the end of the second stage 127 for the aforementioned reasons.

After passing through the WI filters 121, a first subset of periodically spaced channels, e.g. the even channels E′, have a polarization, e.g. vertical, orthogonal to the remaining second subset of channels O. A first PBS 141 redirects the vertically polarized even channels E′, while enabling the horizontally polarized odd channels O to pass therethrough. Similarly, a second PBS 142 redirects the vertically polarized even channels E′, while passing the horizontally polarized odd channels O′ therethrough. A third PBS 143 redirects the even channels E′ into the path of the odd channels O, which pass directly through the third PBS 143. Similarly, a fourth PBS 144 redirects the even channels E into the path of the odd channels O′, which pass directly through the fourth PBS 144.

Before entering third and fourth WI filters 146 and 147, the polarization of the sub-beams containing the odd channels O and O′ is orthogonal to the polarization of the sub-beams containing the even channels E and E′. At this point each sub-beam also includes residual transmission components, i.e. Eo, Oe, E′o′ and O′e. Initial waveplates 148 (e.g. @ 22.5°) are provided to orient the sub-beams before entry into the first stages 149 of birefringent plates. Intermediate waveplates 151 re-orient the sub-beams before entry into second stages 152. After passage through the second states 152, the polarization of the sub-beams with one subsets of channels has been rotated parallel to the polarization of the other sub-beams. Accordingly, half wave plates (HWP) 153 are provided to rotate the state of polarization of one of each pair of sub-beams perpendicular to the other, so that the two sub-beams can be combined by birefringent crystals 154. For convenience, spacers 156 are disposed beside the HWP's 153. Similar to the input ports, the output ports 113 and 114 also include lenses 157 for focusing the combined beams onto an end of a fiber 158, which is encased in a ferrule 159.

With the double stage cross-connect arrangement, all of the residual components, o, e, o′ and e′ are eliminated, and much higher isolation is obtained.

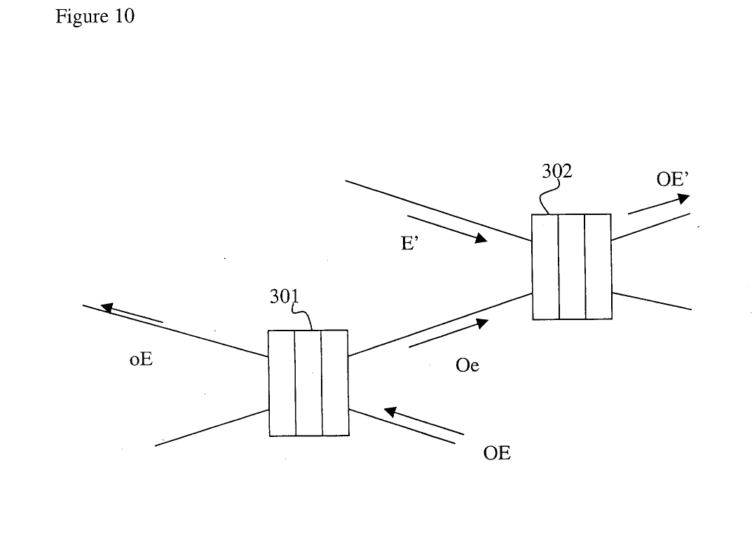

Within the scope of the present invention is the utilization of other wavelength interleaver technologies including those disclosed in FIGS. 10 to 16. FIG. 10 illustrates an embodiment of the present invention in which multi-cavity Fabry-Perot etalon interleavers (MCI) are utilized to perform the wavelength interleaving and add/drop functions of the first embodiment schematically illustrated in FIGS. 3 and 4. A first MCI WI filter 301 separates a first subset of periodically spaced wavelength channels, e.g. even ITU channels E, from a first input beam OE leaving the remaining subset of odd channels O. Both subsets contain unwanted residual transmission components o and e. The first subset of wavelength channels E is output with the residual component o; however the remaining set Oe is sent to a second MCI WI filter 302. The second MCI WI filter 302 combines the set of wavelength channels O with a new set of channels E′, while filtering out the residual component e.

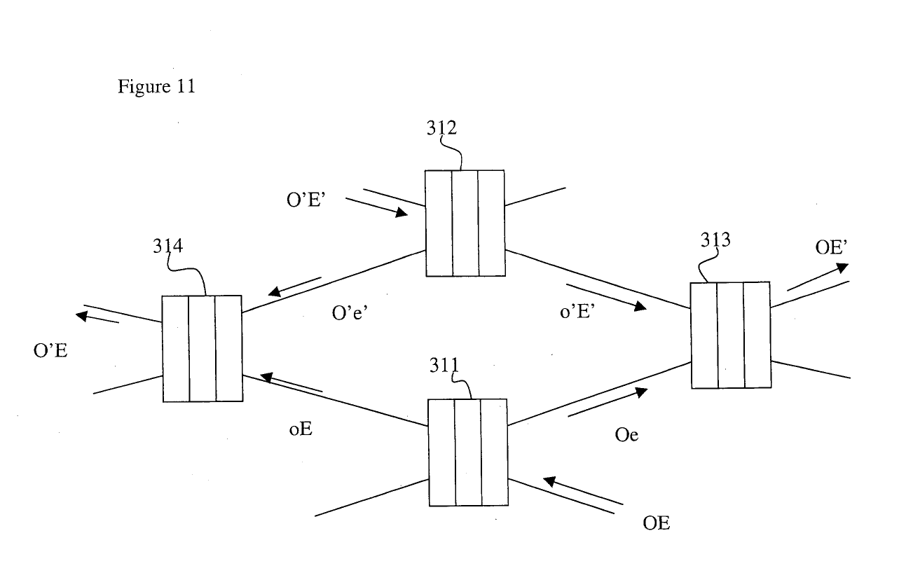

With reference to FIG. 11, which performs the functions of the second embodiment schematically illustrated in FIGS. 7 and 8, a first MCI filter 311 separates a first subset of periodic wavelength channels, e.g. even channels E, from a first input beam OE leaving the remaining subset of odd channels O. Both subsets contain unwanted residual transmission components o and e. Similarly a second MCI filter 312 separates a first subset of periodic wavelength channels, e.g. even channels E′, from a second input beam O′E′ leaving the remaining subset of odd channels O′. Again, both subsets contain unwanted residual transmission components o′ and e′. However, directing the sub-beams Oe and o′E′ through a third MCI filter 313 results in the interleaving of the channels O and E′, and the filtering out of the residual components e and o′. Similarly, directing sub-beams oE and O′e′ through a fourth MCI filter 314 results in the interleaving of channels E and O′, and the filtering out of residual components o and e′.

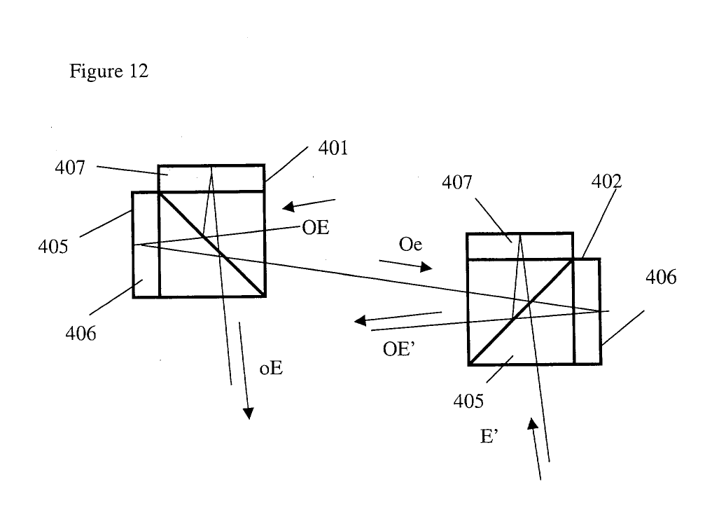

FIG. 12 illustrates the first embodiment (FIGS. 3 and 4) of the present invention utilizing Michelson Gires-Tournois etalon (MGT) interleaver technology. As above, a first MGT filter 401 separates a first subset of periodically spaced wavelength channels, e.g. the even ITU channels, E from the remaining channels O of a first input signal. The first subset E with a residual transmission component o are output without further filtering. The remaining channels O with residual transmission components e are directed to a second MGT WI filter 402, which combines the channels O with a new set of channels E′ and filters out the residual component e. The new set of channels E′ contains wavelength channels with the same center wavelength as those from the original subset E.

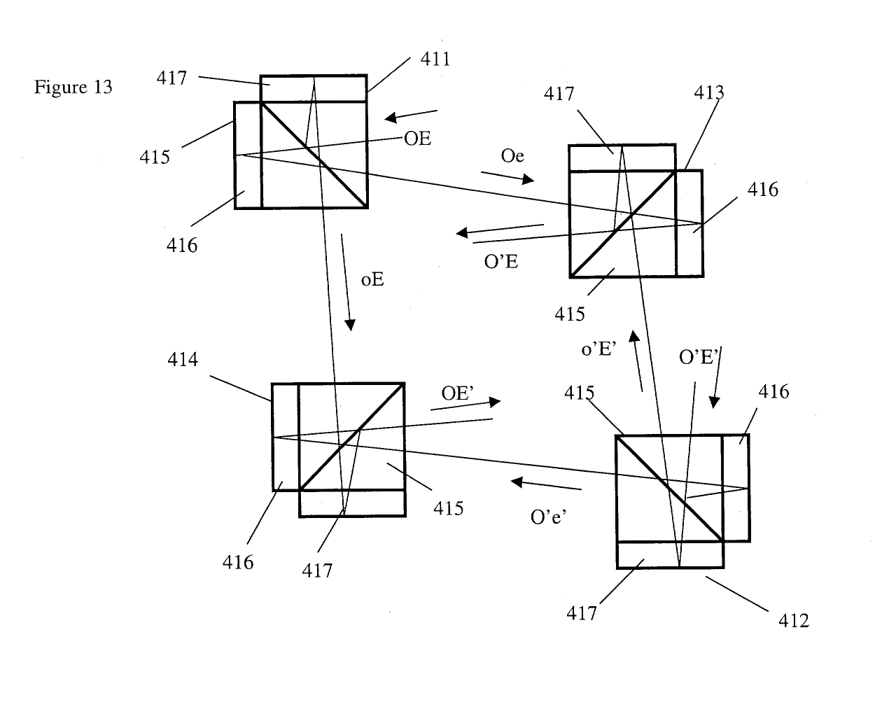

FIG. 13 illustrates another embodiment of the present invention, which utilizes Michelson Gires-Tournois etalon (MGT) interleaver technology. As above, a first MGT filter 411 separates a first subset of periodically spaced wavelength channels, e.g. the even ITU channels, E from the remainder O of a first input signal. A second MGT filter 412 also separates channels from a first subset of periodically space wavelength channels, e.g. the even ITU channels, E′ from the remainder O′ of a second input signal. All of these sub-beams contain residual transmission components, which are filtered out when the subset O is interleaved with the subset E′ in the third MGT filter 413, and when the subset O′ is interleaved with the subset E in the fourth MGT filter 414. Each MGT filter includes a beam splitter 415 and resonant cavities 416 and 417, as is well known in the art.

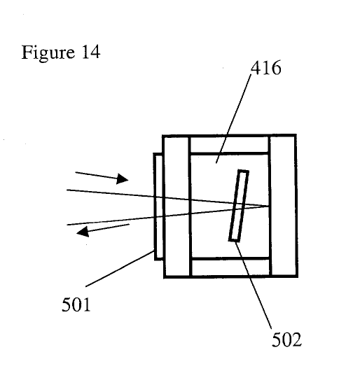

Another embodiment of the present invention utilizes birefringent Michelson Gires-Tournois (BGT) interleaver technology, the layout of which is identical to that of the MGT embodiment, except the beam splitters 415 would be PBS′ and the resonant cavities 416 and 417 would include a first birefringent element 501 (FIG. 14) coupled outside of each resonant cavity and a second birefringent element 502 provided inside each resonant cavity, as is well known in the art.

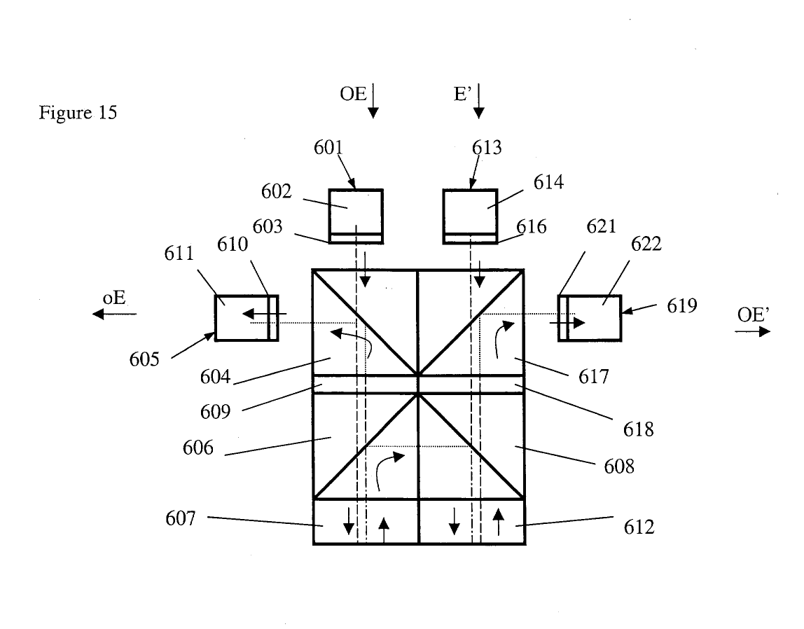

The nature of BCI technology lends itself to alternative embodiments in which a single resonant cavity performs the function of two, since orthogonally polarized sub-beams travel different optical path lengths due to the birefringent material disposed in the resonant cavity. FIG. 15 illustrates an example of the first embodiment utilizing the single cavity BCI technology. A first signal comprising channels from both subsets E and 0 is launched via an input port 601, and divided into two orthogonally polarized sub-beams (only one shown) by a birefringent crystal 602. A half-wave plate 603 rotates the polarization of one of the sub-beams to be the same as the other, in the illustrated example both are vertically polarized. Since both sub-beams undergo the same alterations, only one sub-beam will be considered until the two are recombined.

The sub-beams travel through a first PBS 604 and a second PBS 606 until reaching a first resonant cavity 607, similar to the resonant cavity illustrated in FIG. 14. Due to the selected FSR of the first resonant cavity 607, the polarization of a first subset of periodically spaced channels Oe, e.g. the odd ITU channels, rotates to horizontal while the remaining channels Eo remain vertically polarized. As the first subset of channels Oe returns through the second PBS 606, they are redirected to a third PBS 608, while the remaining channels Eo pass through the second PBS 606 to the first PBS 604. Before entering the first PBS 604 the remaining channels Eo pass through a non-reciprocal rotator 609, which only rotates the polarization of light passing from the second PBS 606 to the first PBS 604. As a result, the remaining channels Eo are redirected by the first PBS 604 to a drop port 605 without filtering out the residual transmission components o. A HWP 610 rotates the polarization of one of the sub-beams perpendicular to the polarization of the other, whereby the two sub-beams are combined by a birefringent crystal 611.

The first subset of channels Oe (horizontally polarized) is again redirected by the third PBS 608 to a second resonant cavity 612, similar to the first resonant cavity 607. Meanwhile, a second signal comprising add channels E′ with center wavelengths the same as those from the remaining set E, is launched via an add port 613. Again the signal is divided into two orthogonally polarized sub-beams by a birefringent crystal 614, and the polarization of one sub-beam is rotated by a HWP 616 so that both sub-beams have the same polarization, e.g. vertical. The sub-beams pass through a fourth PBS 617 and the third PBS 608, and are combined with the first subset of channels Oe in the second resonant cavity 612. The polarization of the first subset of channels O is again rotated in the second resonant cavity 612, whereby both the first subset O and the add channels E′ have the same polarization, e.g. vertically polarized. The residual transmission components remain horizontally polarized and will be filtered out. The combined signal E′O passes through the third PBS 608 to the fourth PBS 617; however, before entering the fourth PBS 617 the combined signal E′O passes through a second non-reciprocal rotator 618, which only rotates the polarization of light passing from the third PBS 608 to the fourth PBS 617. Accordingly, the combined signal becomes horizontally polarized and gets redirected to an output port 619. A HWP 621 rotates the polarization of one of the sub-beams, thereby enabling a birefringent crystal 622 to recombine the two sub-beams for output.

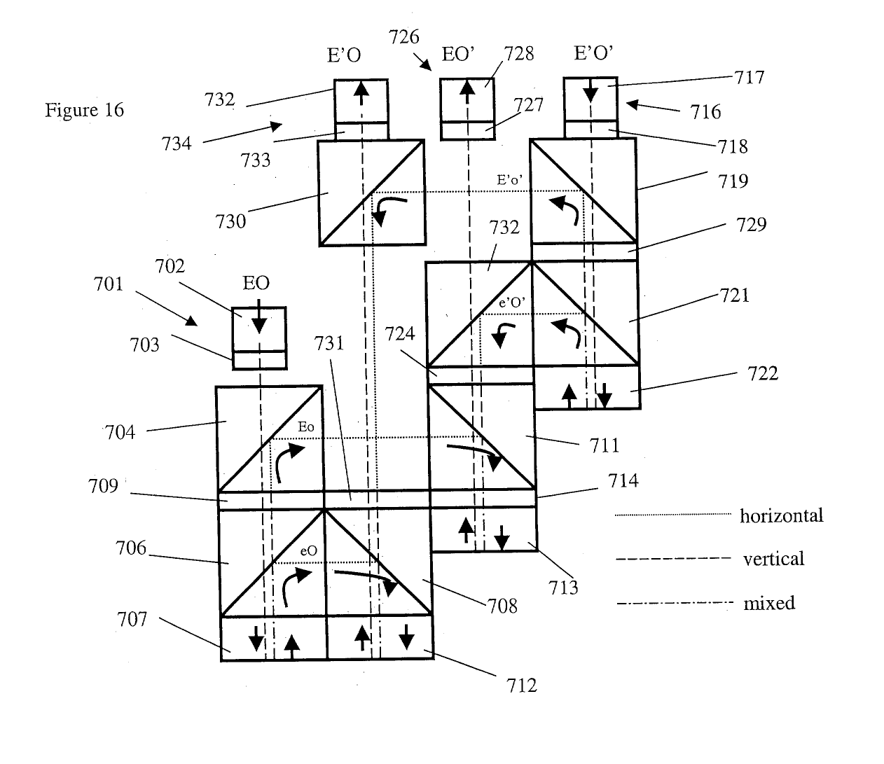

FIG. 16 illustrates the second embodiment of the present invention utilizing single cavity BCI technology. As in the aforementioned first embodiment, a first input signal is launched via a first input port 701 and separated into two orthogonally polarized sub-beams (one of which is shown) by a birefringent crystal 702. The polarization of one of the sub-beams is rotated by 90° by a HWP 703, whereby both sub-beams have a polarization, e.g. vertical, that passes through a first PBS 704 and a second PBS 706 to a first resonant cavity 707. In the first resonant cavity 707, the polarization of a first set of periodically spaced channels O, e.g. odd ITU channels, is rotated by 90°, while the polarization of the remaining channels E, e.g. even ITU channels, stays the same. Accordingly, the first set of channels O gets redirected by the second PBS 706 to a third PBS 708, while the remaining set of channels E passes through the second PBS 706 to the first PBS 704. However, before entering the first PBS 704, the polarization of the remaining set of channels E is rotated by 90° by a non-reciprocal rotator 709, e.g. a Faraday rotator, so that the remaining set of channels E is redirected to a fourth PBS 711. The third PBS 708 directs the first subset O to a second resonant cavity 712, while the fourth PBS 711 directs the remaining subset E to a third resonant cavity 713. Before entering the third resonant cavity 713, the polarization of the remaining subset E is rotated by 90° by a non-reciprocal rotator 714, whereby the polarization of the first subset E is back to vertical.

Meanwhile, a second input signal is launched via a second input port 716, and divided into two sub-beams (only one shown) by a birefringent crystal 717. A HWP 718 rotates the polarization of one of the sub-beams so that both sub-beams have the same polarization, e.g. vertical, which enables them to pass through a fifth PBS 719 and a sixth PBS 721 to a fourth resonant cavity 722. Again, the polarization of a first subset of channels O′ is rotated by 90°, while the polarization of the remaining subset of channels E′ in the fourth resonant cavity 722. As a result, the first subset O′ is redirected by the sixth PBS 721 to a seventh PBS 723, which redirects the first subset O′ to the fourth PBS 711. Before entry into the fourth PBS 711, a non-reciprocal rotator 724 rotates the polarization of the first subset O′, e.g. to vertically polarized, to enable the beam to pass through the fourth PBS 711 to the third resonant cavity 713. Before entry into the third resonant cavity 713 the polarization of the first subset O′ is again rotated by the non-reciprocal rotator 714 back to horizontally polarized. Therefore, the horizontally polarized first subset O′ is combined with the vertically polarized remaining subset E in the third resonant cavity 713. The polarization of the first subset O′ is again rotated to vertically polarized to enable the newly formed combined beam EO′ to pass through the fourth and seventh PBS 711 and 723 to a first output port 726. A HWP 727 rotates the polarization of one of the sub-beams perpendicular to the other so that a birefringent crystal 728 can combine the sub-beams for output.

The remaining subset E′ passes through the sixth PBS 721 towards the fifth PBS 719, but before entering therein, passes through a non-reciprocal rotator 729, which rotates the polarization from vertical to horizontal. As a result, the remaining subset E′ is redirected by the fifth PBS 719 to an eighth PBS 730, which redirects the sub-beams containing the remaining subset E′ towards the third PBS 708. Before entering the third PBS 708, the polarization of the sub-beams containing the remaining subset E′ is rotated by 90° by a non-reciprocal rotator 731, so that the sub-beams will pass through the third PBS 708 to the second resonant cavity 712. The first subset of channels O and the remaining subset E′ are combined in the second resonant cavity 712, and the polarization of the first subset of channels O is rotated by 90°, whereby the combined beam E′O has a polarization, e.g. vertically polarized, that enables it to pass through the third and eighth PBS 708 and 731 to a second output port 732. As before, a HWP 733 rotates the polarization of one of the sub-beams, whereby a birefringent crystal 734 combines the two sub-beams for output.

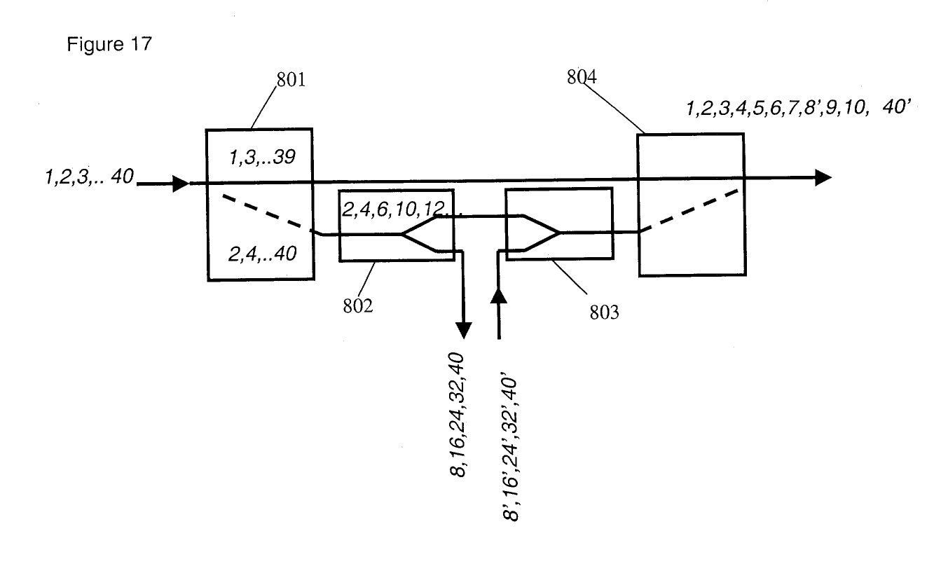

Various multi-stage arrangements are conceivable utilizing the present invention, including the one illustrated in FIG. 17, in which a first WI filter 801 separates the odd channels from the even channels, and a second WI filter 802 separates every fourth even channel, i.e. 8, 16, 24 and 32 from the remainder of the even channels. A third WI filter 803 adds new channels 8′, 16′, 24′ and 32′ to the remainder of the even channels, and a fourth WI filter 804 combines the original odd channels with the newly combined set of even channels. In this case, each channel is filtered at least twice, while some even channels are filtered four times, thereby increasing isolation even more. The new channels that are added do not necessarily comprise all of the dropped channels. Moreover, the new channels could possibly comprise more channels than the dropped channels, if the additional channels do not have center wavelengths the same as existing channels in the input signal.

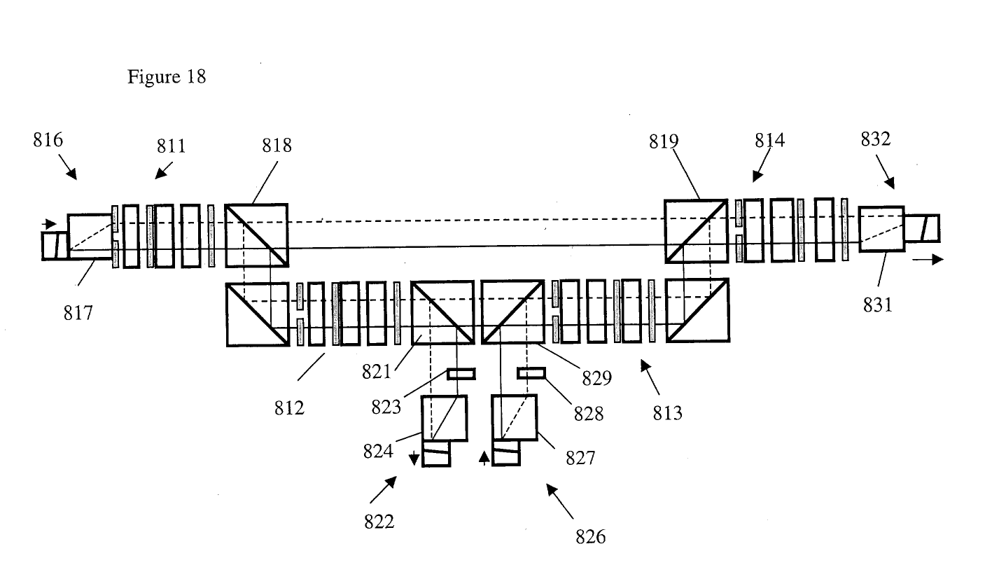

The BCI version of the third embodiment is illustrated in FIG. 18, and includes a first BCI WI filter 811, a second BCI filter 812, a third BCI WI filter 813, and a fourth BCI WI filter 814. Each BCI WI filter is substantially the same as those hereinbefore described with reference to FIGS. 5, 6 and 9. An input signal is launched via an input port 816, and separated into orthogonal sub-beams by a birefringent crystal 817. The first BCI WI filter 811 facilitates the separation of a first and a second subset of channels by rotating the polarization of the second subset of periodically spaced channels. The first subset of channels passes through a first PBS 818 and travels to a second PBS 819. The second subset of channels is redirected to the second BCI WI filter 812, in which a third subset of periodically spaced channels is separated from a fourth subset of channels. The sub-beams containing the third subset of channels are redirected by a third PBS 821 to a first output port 822. A HWP 823 rotates the polarization of one of the sub-beams containing the third subset of channels so that a birefringent crystal 824 can combine them for output. A second input signal containing a fifth subset of channels is launched via a second input port 826. A birefringent crystal 827 separates the input signal into two orthogonally polarized sub-beams, and a HWP 828 rotates the polarization of one of the sub-beams so both sub-beam can be redirected by a fourth PBS 829 to the third BCI WI filter 813 along with the fourth subset of channels from the second BCI WI filter 812. The fifth subset of channels are defined by center wavelengths the same as the third subset of channels that were previously dropped via the first output port 822. The fourth and fifth subsets of channels are combined in the third BCI WI filter 813 forming first combined sub-beams, and the polarization of the sub-beams containing the fourth subset of channels is rotated so that all of the light is redirected by the second PBS 819 to the fourth BCI WI filter 814. The fourth BCI WI filter 814 combines the first combined sub-beams with the sub-beams containing the first subset of channels forming second combined sub-beams. A birefringent crystal 831 combines the second combined sub-beams for output via a second output port 832.

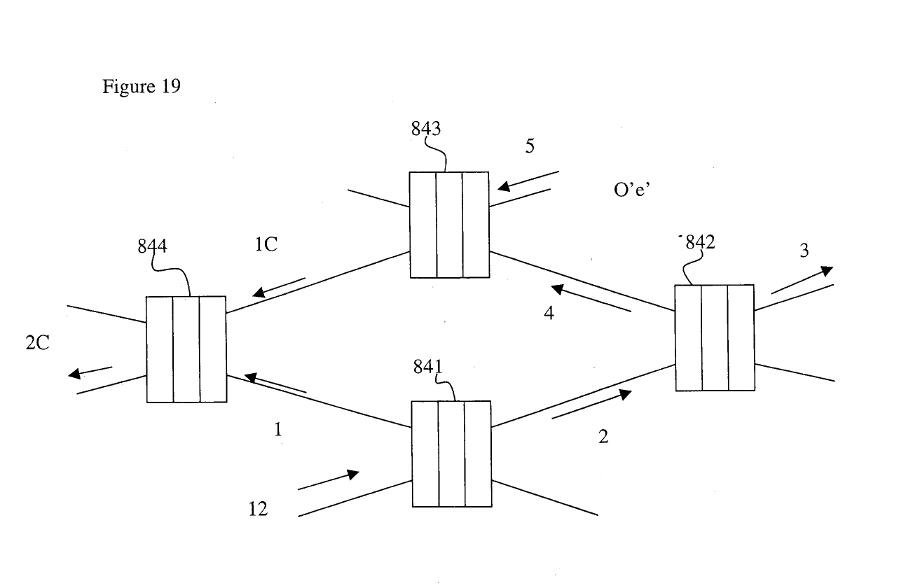

With reference to FIG. 19, a MCI version of the third embodiment includes first, second, third and fourth MCI WI filters 841 to 844, respectively. The first MCI WI filter directs a first subset of channels to the fourth MCI WI filter 844, while directing a second subset of periodically spaced channels to the second MCI WI filter 842. The second MCI WI filter divides the second subset of channels into third and fourth subsets. The third subset is dropped via an output port, while the fourth subset is directed to the third MCI WI filter 843. A fifth subset of channels is combined with the fourth subset of channels in the third MCI WI filter 843, and the light containing the combined set of channels is directed to the fourth MCI WI filter. The channels in the fifth subset are defined by center wavelengths, which are the same as those in the third subset of channels. The combined set of channels and the first subset of channels are combined in the fourth MCI WI filter 844 and output via another output port.

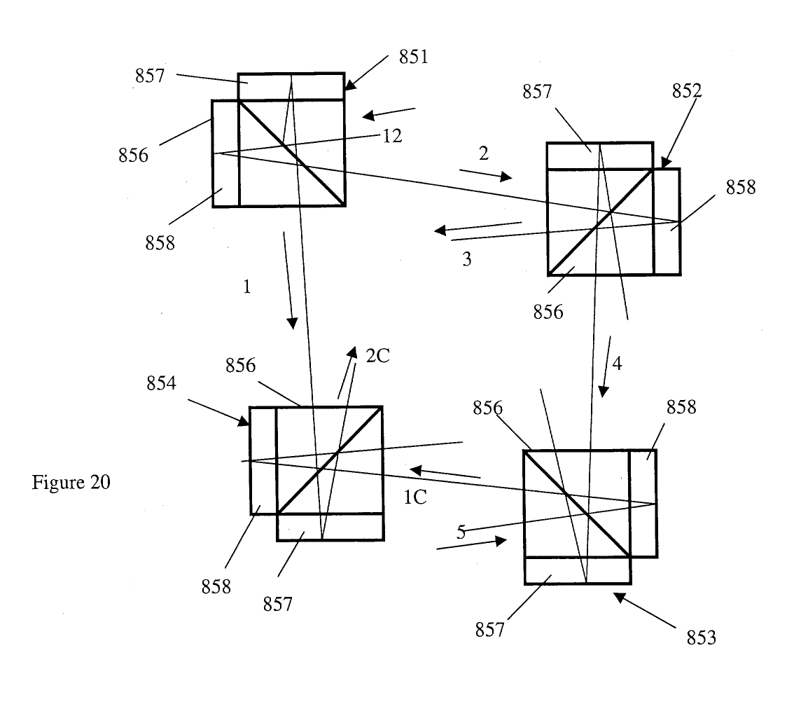

An MGT and angled BGT versions of the third embodiment are illustrated in FIG. 20, and include first, second, third and fourth MGT (or BGT) WI filters 851 to 854, respectively. Each MGT (or BGT) WI filter comprises a beam splitter 856 (a PBS in the BGT case) two resonant cavities 857 and 858. As before, a first input signal is separated into first and second subsets of channels by the first WI filter 851, and the first subset is directed towards the fourth WI filter 854, while the second subset is directed towards the second WI filter 852. The second WI filter 852 further splits the second subset into third and fourth subsets of channels, and directs the third subset to a first output port. The fourth subset of channels is directed to the third WI filter 853 for combination with a fifth subset of channels launched via a second input port. The fifth subset of channels comprises channels with center wavelengths the same as those of the third subset of channels. The combined fourth and fifth subsets of channels are directed to the fourth WI filter 854 for combination with the first subset of channels from the first WI filter 851. The resultant beam is output a second output port.

We claim:

1. An add/drop multiplexing device comprising:
a first port for launching a first signal comprising a plurality of wavelength channels;
a first wavelength interleaving filter for separating a first subset of periodically spaced channels, defined by a first set of center wavelengths, from a second subset of channels, defined by a second set of center wavelengths, the second subset of channels including some residual transmission components of the first subset of channels;
a second port for launching a second signal comprising a third subset of channels, each channel defined by a center wavelength from the first set of center wavelengths;
a second wavelength interleaving filter for combining the second subset of channels with the third subset of channels into a third signal, while filtering out residual transmission components of the first subset of channels; and
a third port for outputting the third signal.

2. The device according to claim 1, wherein the second signal further comprises a fourth subset of channels, each defined by a center wavelength from the second set of center wavelengths; wherein the device further comprises:
a third wavelength interleaving filter for separating the third subset of channels from the fourth subset of channels, the fourth subset of channels including residual transmission components from the third subset of channels;
a fourth wavelength interleaving filter for combining the first subset of channels with the fourth subset of channels into a fourth signal, while filtering out residual transmission components from the third subset of channels; and
a fourth port for outputting the fourth signal.

3. The device according to claim 1, wherein the first and second wavelength interleaving filters are selected from the group of interleavers consisting of birefringent crystal interleavers; Michelson Gires-Tournois interleavers; birefringent Michelson Gires-Tournois interleavers; and multi-cavity etalon interleavers.

4. The device according to claim 2, wherein the first, second, third and fourth wavelength interleaving filters are selected from the group of interleavers consisting of birefringent crystal interleavers; Michelson Gires-Tournois interleavers; birefringent Michelson Gires-Tournois interleavers; and multi-cavity etalon interleavers.

5. The device according to claim 1, wherein the first wavelength interleaving filter comprises: a first stack of birefringent plates for orienting the first subset of channels with a polarization orthogonal to a polarization of the second subset of channels; and a polarization beam splitter for directing the second subset of channels to the second wavelength interleaving filter, and for directing the first subset of channels to a drop port.

6. The device according to claim 5, wherein the second wavelength interleaving filter comprises: a second stack of birefringent plates for orienting the second subset of channels with a same polarization as the third subset of channels; and a polarization beam combiner for directing the second and the third subsets of channels to the second stack of birefringent plates.

7. The device according to claim 6, wherein the polarization beam splitter and the polarization beam combiner are the same polarization beam splitter (PBS) cube.

8. The device according to claim 2, wherein the first wavelength interleaving filter comprises: a first stack of birefringent plates for orienting the first subset of channels with a polarization orthogonal to a polarization of the second subset of channels; and a polarization beam splitter for directing the second subset of channels to the second wavelength interleaving filter, and for directing the first subset of channels to the fourth wavelength interleaving filter;
wherein the third wavelength interleaving filter comprises: a second stack of birefringent plates for orienting the third subset of channels with a polarization orthogonal to a polarization of the fourth subset of channels; and a polarization beam splitter for directing the third subset of channels to the second wavelength interleaving filter, and for directing the fourth subset of channels to the fourth wavelength interleaving filter;
wherein the second wavelength interleaving filter comprises: a third stack of birefringent plates for orienting the second subset of channels with a same polarization as the third subset of channels; and a polarization beam combiner for directing the second and the third subsets of channels to the third stack of birefringent plates; and
wherein the fourth wavelength interleaving filter comprises: a fourth stack of birefringent plates for orienting the first subset of channels with a same polarization as the fourth subset of channels; and a polarization beam combiner for directing the first and the fourth subsets of channels to the fourth stack of birefringent plates.

9. The device according to claim 1, wherein the first wavelength interleaving filter comprises: a first Gires-Tournois resonant cavity with first and second birefringent elements for orienting the first subset of channels with a polarization orthogonal to a polarization of the second subset of channels; a first PBS for directing the first subset of channels to a drop port, and for directing the second subset of channels to the second wavelength interleaving filter; and
wherein the second wavelength interleaving filter comprises: a second Gires-Tournois resonant cavity with third and fourth birefringent elements for orienting the second subset of channels with a same polarization as the third subset of channels; a second PBS for directing the second and third subsets of channels to the second wavelength interleaving filter, and for directing the third signal to the third port.

10. The device according to claim 9, further comprising:
a first non-reciprocal rotator for rotating the polarization of the first subset of channels traveling between the first PBS and the drop port;
a third PBS for redirecting the first subset of channels to the drop port;
a second non-reciprocal rotator for rotating the polarization of the third signal traveling between the second PBS and the third port; and
a fourth PBS for redirecting the third signal to the third port.

11. The device according to claim 1, wherein the first subset of channels comprises a group of periodically spaced ITU channels.

12. The device according to claim 1, wherein the first subset of channels comprises a group of alternately spaced ITU channels.

13. The device according to claim 2, wherein the first subset of channels comprises a group of periodically spaced ITU channels.

14. The device according to claim 2, wherein the first subset of channels comprises a group of alternately spaced ITU channels.

15. An add/drop multiplexing device comprising:
a first port for launching a first signal comprising a plurality of wavelength channels;
a first wavelength interleaving filter for separating a first subset of periodically spaced channels from a second subset, the first subset of channels including some residual transmission components of the second subset of channels;
a second wavelength interleaving filter for separating the second subset of channels into a third subset of periodically spaced channels and a fourth subset of channels;
a second port for receiving the third subset of periodically spaced channels;
a third port for launching a fifth subset of periodically spaced channels, the fifth subset of channels having center wavelengths the same as center wavelengths of the fourth subset of channels;
a third wavelength interleaving filter for combining the fifth subset of channels with the fourth subset of channels forming a first combined set of channels;
a fourth wavelength interleaving filter for combining the first combined set of channels with the first subset of channels forming a second combined set of channels, while filtering out some residual transmission components of the second subset of channels; and
a fourth port for outputting the second combined set of channels.

16. The device according to claim 15, wherein the first, second, third and fourth wavelength interleaving filters are selected from the group of interleavers consisting of birefringent crystal interleavers; Michelson Gires-Tournois interleavers; Michelson birefringent Gires-Tournois interleavers; and multi-cavity etalon interleavers.

17. The device according to claim 15, wherein the first subset of channels comprises a group of periodically spaced ITU channels.

18. The device according to claim 15, wherein the first subset of channels comprises a group of alternately spaced ITU channels.
